(19) United States
(12) Patent Application Publication
(10) Pub. No.: US 2003/0156212 A1
(43) Pub. Date: Aug. 21, 2003

(54) Digital camera

(76) Inventors: Yasuhiro Kingetsu, Osaka (JP); Kenji Nakamura, Osaka (JP); Takeru Butsusaki, Osaka (JP)

Correspondence Address: MCDERMOTT WILL & EMERY, 600 13TH STREET, N.W., WASHINGTON, DC, 20005-3096, US

(21) Appl. No.: 10/369,127

(22) Filed: Feb. 20, 2003

(30) Foreign Application Priority Data
Feb. 20, 2002 (JP) 2002-43156

(51) Int. Cl. H04N 5/222

(52) U.S. Cl. 348/333.12

(57) ABSTRACT

A digital camera 1 comprises an EVF 22 whose frame rate is changeable. Image data captured by a CCD 41 are transferred to each processing part via a bus line 45. During continuous frame recording of the digital camera 1, the CCD 41, an image processing part 55, a video controller 56, a compression part 57 and a memory card controller 58 respectively perform the respective processing in parallel, and the volume of data transferred on the bus line 45 reaches a peak. Hence, during continuous frame recording, the video controller 56 reduces the frame rate of the EVF 22, to thereby suppress the volume of data transferred on the bus line 45. This lowers a load upon the digital camera 1.

This application is based on application No. 2002-43156 filed in Japan, the content of which is hereby incorporated by reference.

### BACKGROUND OF THE INVENTION

1. Field of the Invention

The present invention relates to a technique for reducing a load upon a digital camera.

2. Description of the Related Art

In digital cameras these years, the number of pixels, and thus the volume of acquired image data increases and the volume of data to be processed in a digital camera accordingly increases. Such an increase in data volume is a load upon a processing system as a whole, such an internal bus for data transfer and an incorporated circuit for processing data, of the digital camera, which is one of obstacles against an improvement in operation speed of the digital camera.

In a digital camera which has a continuous frame recording capability in particular, as the volume of data to be processed increases during continuous frame recording and the increased data volume exceeds the capacity of the internal bus or for other reasons. Thus, during continuous frame recording which requires a high operation speed, the operation speed during continuous frame recording ends up in decreasing.

Noting this, a technique for improving an operation time by means of reduction in load upon a digital camera has been proposed. For example, intervals of generating live view-purpose image data are extended by three times of regular intervals after capturing of recording-purpose image data in an attempt to improve the operability during continuous frame recording.

However, in the digital camera described above, a frame rate of a display which provides a live view is fixed. Hence, it is necessary to read out image data generated and stored in an internal memory at a predetermined frame rate, and therefore, a data transfer volume in an internal bus does not decrease largely. Further, there is no consideration given on continuous frame recording which particularly increases a load upon the digital camera and requires high-speed operations.

### SUMMARY OF THE INVENTION

The present invention has been made in light of the problems described above, and therefore, a first object of the present invention is to provide a technique which makes it possible to reduce a load upon a digital camera.

A second object of the present invention is to provide a technique which makes it possible to improve a speed while reducing a load during continuous frame recording of a digital camera.

To solve the problems above, one aspect of the present invention is a digital camera equipped with image capturing device which acquires image data of an object, comprising a display controller which makes a display device whose frame rate is changeable display displaying-purpose image data at a predetermined reference frame rate, and judging part which determines a load upon said digital camera, wherein said display controller reduces the frame rate of said display device smaller than said reference frame rate when said judging part determines that a load upon said digital camera is larger than a reference load which is imposed during normal operations.

The digital camera further comprises image capture controller which makes said image capturing device execute continuous frame recording of acquiring a plurality pieces of image data representing the object over successive points in time, wherein said judging part determines that a load upon the digital camera is larger than the reference load which is imposed during normal operations when said image capture controller makes said image capturing device execute continuous frame recording.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a front view showing the essential structure of the digital camera.

FIG. 2 is a top view showing the essential structure of the digital camera.

FIG. 3 is a back view showing the essential structure of the digital camera.

FIG. 4 shows the internal structure of the digital camera as functional blocks.

FIG. 5 shows, as functional blocks, the functions realized by the image processing part.

FIG. 6 shows an example of the signals transmitted to the EVF from the video controller.

FIG. 7 schematically shows the areas assigned to the image memory.

FIG. 8 shows the flow of the basic operations in the recording mode of the digital camera.

FIG. 9 is a drawing for describing the content of the processing during the live view operation of the digital camera.

FIG. 10 is a drawing for describing the content of the processing during the single frame recording operation of the digital camera.

FIG. 11 shows the flow of the single frame recording operation.

FIG. 12 shows the flow of the continuous frame recording operation according to the first preferred embodiment.

FIG. 13 shows the flow of the continuous frame recording operation according to the second preferred embodiment.

FIG. 14 is a drawing for describing the content of the processing during the continuous frame recording operation according to the second preferred embodiment.

FIG. 15 is a drawing for describing the content of the processing performed on image data during the continuous frame recording operation according to the third preferred embodiment.

FIG. 16 shows the flow of the continuous frame recording operation according to the third preferred embodiment.

### DETAILED DESCRIPTION OF THE PREFERRED EMBODIMENTS

Preferred embodiments of the present invention will now be described with reference to the associated drawings.

<1. First Preferred Embodiment>

<1-1. Structure of Digital Camera>

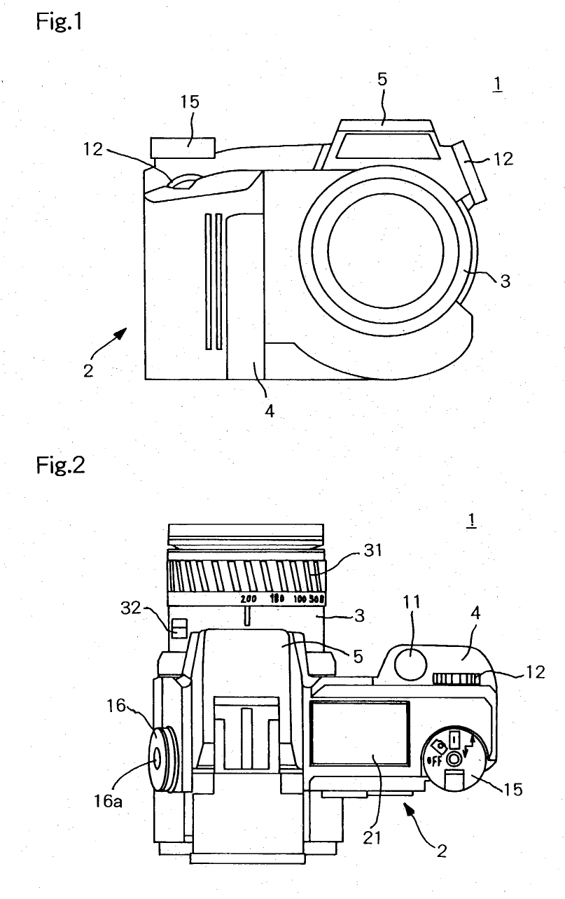

FIGS. 1 through 3 are drawings which show an essential structure of a digital camera 1 according to a preferred embodiment of the present invention. As shown in FIGS. 1 and 2, the digital camera 1 is formed mainly by a camera main unit 2 and a taking lens 3.

The taking lens 3 is structured-as a zoom lens comprising a plurality of lens units, and a magnification (focal length) is changed as a zoom ring 31 which is disposed to a peripheral portion is rotated. A macro switch 32 is disposed to the taking lens 3, and as the macro switch 32 is slid, macro photographing can be realized. Further, a shutter structure of the digital camera 1 is of the mechanical type, and a mechanical shutter (not shown) is arranged at an appropriate position inside the taking lens 3.

As shown in FIG. 1, disposed to a front surface of the camera main unit 2 are a grip part 4 located at a left-hand side edge portion and a built-in flash 5 located at a right-hand side top portion, meanwhile a shutter start button 11 (referred as “shutter button 11” herein below) is disposed to the top surface of the grip part 4 as shown in FIG. 2. The shutter button 11 has a 2-stage switch with which it is possible to detect a half-pressed state (referred as “S1” in the drawings) and a full-pressed state (referred as “S2” in the drawings).

As shown in FIG. 2, to a right-hand portion of the top surface of the camera main unit 2, a main switch 15 of a dial type is disposed for switching between ON and OFF of a power source, “recording mode,” “playback mode” and “communication mode.”

The recording mode is an operation mode during which an object is taken and image data (hereinafter referred to as “image(s)” when appropriate) are acquired and recorded in a memory card 9. The playback mode is an operation mode for reading out image data recorded in the memory card 9 and reproducing and displaying the image data. Further, the communication mode is an operation mode for communication such as transfer of image data to an external computer via a USB terminal 27 which is disposed to the back surface of the camera main unit 2.

On the left-hand side to the main switch 15, a data panel 21 is disposed which displays various types of setting information regarding the digital camera 1, thereby making it possible to easily grasp the setting information.

Further, to an upper portion within a side surface of the digital camera 1, a function dial 16 and a function button 16a are disposed which are for setting items such as “exposure mode,” “image compression rate,” “white balance” and “drive mode” regarding acquired image data. After dialing to an item-to-be-set using the function dial 16, a select dial 12 disposed to an upper portion of the grip part 4 is rotated while pressing the function button 16a, and the settings of the item are changed one after another.

For instance, as for the item “drive mode,” it is possible to switch the setting between “single frame recording” for acquiring image data for one frame at a time and “continuous frame recording” for acquiring a plurality pieces of image data while the shutter button 11 remains pressed to the full-pressed state.

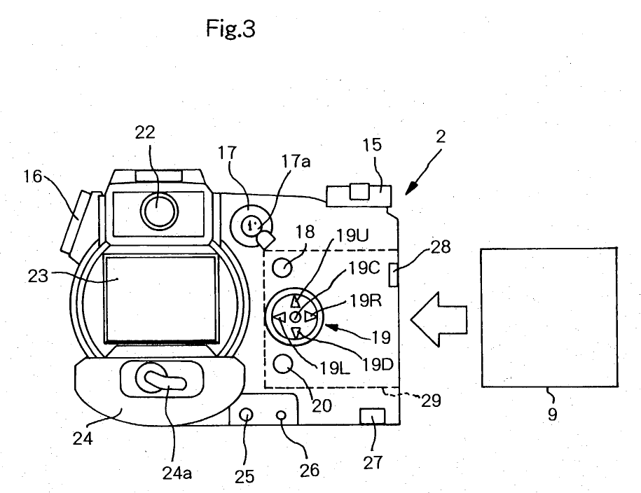

As shown in FIG. 3, on a left-hand side portion within the back surface of the camera main unit 2, it is provided an electronic view finder (EVF) 22 and a liquid crystal display (LCD) 23 for live view of a image data representing an object, reproduction and displaying of recorded image data, a variety types of settings, etc. Used in the EVF 22 and the LCD 23 are liquid crystals of the frame sequential method which allows to display R (red), G (green) and B (blue) colors one after another at a high speed. In addition, frame rates of the EVF 22 and the LCD 23 are changeable, and the frame rates are changed in accordance with a necessity.

It is possible to switch between a display provided by the EVF 22 and a display provided by the LCD 23 by operating a display switch lever 17 which is disposed on the right-hand side to the EVF 22. Meanwhile, a central portion of the display switch lever 17 is an information display switch button 17a, and therefore, when an image is displayed by the EVF 22 or the LCD 23, it is possible to switch whether or not to display setting information and the like at the same time.

In addition, a menu button 18 and a cross key 19 are disposed on the right-hand side to the LCD 23. The cross key 19 contains a 4-way switch, which consists of an up switch 19U, a down switch 19D, a left switch 19L and a right switch 19R, and a center button 19C. The LCD 23 shows a setting menu when the menu button 18 is pressed, and as one operates the cross key 19 while referring to the setting menu, one can determine basic settings of the digital camera 1.

A quick view/delete button 20 is disposed below the cross key 19. In the recording mode, the quick view/delete button 20 functions as a quick view button for simplified playback of image data which were taken immediately before, while in the playback mode, the quick view/delete button 20 functions as a delete button for deleting data of currently reproduced image from the memory card 9.

A battery chamber 24 is disposed in a lower portion of the camera main unit 2. A lid of the battery chamber 24 is opened with a battery chamber open lever 24a, and four AA batteries are set in. Although a normal drive source for the portable digital camera 1 is AA batteries which are set in the battery chamber 24, another drive source may be used which is dc power supplied from outside through a power source input terminal 25 disposed on the right-hand side to the battery chamber 24.

A video output terminal 26 is disposed on the right-hand side to the power source input terminal 25, which makes it possible to transfer image data to an external monitor so that the external monitor displays the image data.

A card slot 29 is disposed inside the camera main unit 2, so that the memory card 9 in which image data and the like are recorded can be inserted at a side surface of the camera main unit 2 and fit in the card slot 29. In the vicinity of an insertion inlet of the card slot 29, an access lamp 28 is disposed which is for showing that accessing to the memory card 9 is ongoing.

<1-2. Internal Structure of Digital Camera>

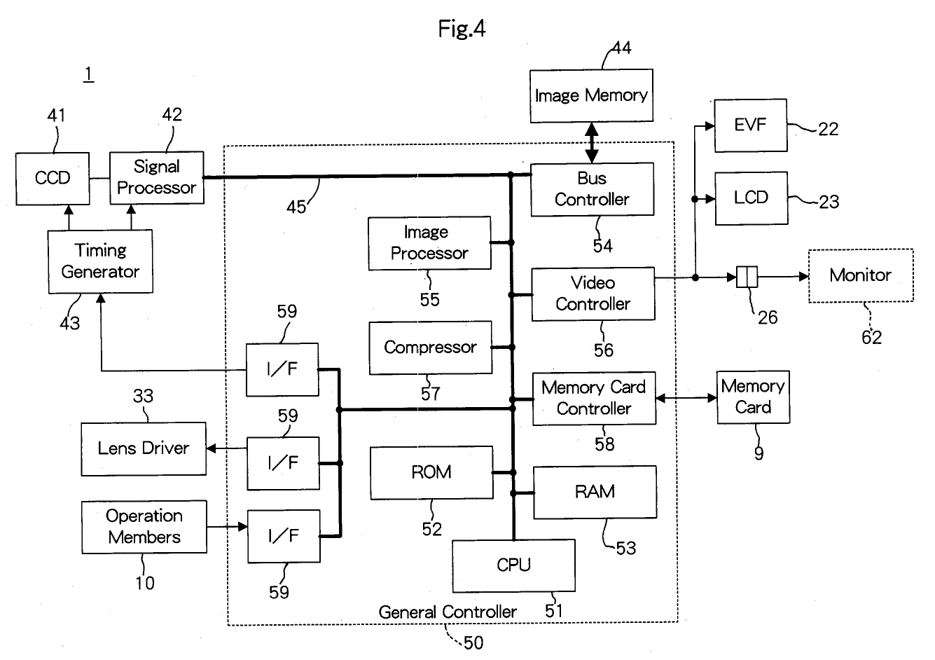

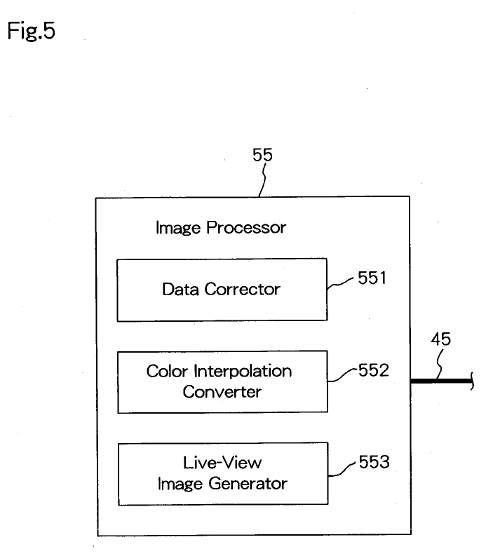

FIG. 4 is a drawing which shows a principal internal structure of the digital camera 1 as function blocks.

A CCD 41 is an image capturing element comprising 2560 pixels in the horizontal direction×1920 pixels in the vertical direction for instance, which performs photoelectric conversion of an optical image of an object obtained by the taking lens 3 into a image signal (which is a signal formed by a signal string of pixel signals generated from light received at the respective pixels) and outputs the image signal as an image data. An image capturing surface of the CCD 41 contains an arrangement of pixels which are associated with the respective color components in the Bayer arrangement, and each pixel detects a luminance component in one of the R (red), the G (green) and the B (blue) colors of the Bayer arrangement.

As output mode for outputting an image signal, the CCD 41 has a frame mode for obtaining image data containing all of 2560 pixels in the horizontal direction×1920 pixels in the vertical direction and a draft mode for obtaining a low-resolution image data containing 2560 pixels in the horizontal direction×240 pixels in the vertical direction which are obtained by reducing data in the vertical direction down to ⅛. The CCD 41 is set to the draft mode for a high speed when simplified live view-purpose image data are desired, but to the frame mode when recording-purpose image data are desired after issuance of a recording instruction.

A signal processing circuit 42 executes predetermined signal processing on an image signal (analog signal) outputted from the CCD 41. A CDS (correlated double sampling) circuit, an AGC (automatic gain control) circuit, an A/D convertor and the like are disposed inside the signal processing circuit 42. The CDS circuit reduces a noise in the image signal while the gain of the AGC circuit is adjusted for adjustment of the level of the image signal. Further, the A/D convertor converts an analog signal representing each pixel into a digital signal having 12 bits for example.

Image data outputted from the signal processing circuit 42 are of the RAW data in which each pixel value has only one color component among R, G and B which correspond to the Bayer arrangement. The image data are transferred through a bus line 45 disposed inside the digital camera 1 and fed to an overall control part 50.

A timing generator 43 generates a drive control signal which is to be supplied to the CCD 41 and the signal processing circuit 42 based on a signal received from the overall control part 50 and outputs the drive control signal. For instance, the timing generator 43 generates a signal such as a timing signal which instructs to start or stop integration of received light amounts, an output control signal (including a change signal for changing the output mode to the draft mode, the frame mode, etc.) for the image signal, etc., and outputs thus generated signal to the CCD 41 and the signal processing circuit 42.

For the digital camera 1 to acquire live view-purpose image data, the drive control signal is supplied to the CCD 42 or the like such that the acquisition rate will become 30 fps (frames per second) for example. Meanwhile, when the “drive mode” is set to “continuous frame recording” at the time of acquisition of recording-purpose image data, the drive control signal is outputted such that the CCD 42 or the like will perform predetermined operations for continuous frame recording. A continuous frame recording operation of the digital camera 1 will be described later.

A lens drive part 33 drives the lens units contained in the taking lens 3, aperture diaphragm which adjusts the amount of incident light, the mechanical shutter and the like based on a signal received from the overall control part 50.

An operation member 10 comprises the shutter button 11, the function dial 16, the menu button 18, the cross key 19 and the like described above. The content of an operation made with the operation member 10 is fed as a signal to the overall control part 50. In addition, information which is set using the operation member 10 is stored in a RAM 53 or the like disposed within the overall control part 50.

The overall control part 50 governs and controls the digital camera 1 as a whole, and is formed comprising a micro computer. To be more specific, the overall control part 50 comprises a CPU 51 which is a main unit, a ROM 52 which stores a control program and the like, and the RAM 53 which serves as a work area, all of which are connected by the bus line 45. The overall control part 50 further comprises a bus controller 54, an image processing part 55, a video controller 56, a compression part 57, a memory card controller 58 and a serial interface (I/F) 59, which are also connected by the same bus line 45.

The bus controller 54 is connected with an image memory 44 in which various types (formats) of image data are stored, and controls transfer between the respective processing parts of the overall control part 50 and the image memory 44 via the bus line 45. The bus controller 54 has an arbitration function for arbitration among a plurality of requests for transfer via the bus line 45 and for satisfying the respective requests.

In addition, the bus controller 54 has a function to serve also as a DMA controller, and realizes direct transfer of image data (so-called DMA transfer) between a processing part of the overall control part 50 making a request and the image memory 44 without utilizing processing executed by the CPU 51.

The image processing part 55 is formed by a dedicated chip which is for performing variety types of image processing on image data acquired by the CCD 41. FIG. 5 shows functions realized by the image processing part 55 as function blocks. As shown in FIG. 5, principal functions of the image processing part 55 are illustrated as a data correction part 551, a color interpolation converting part 552 and a live view image generating part 553.

The data correction part 551 executes a variety types of correction processing, such as black level correction, white balance correction and r correction, on image data. Based on parameters set by the CPU 51, each piece of image data is corrected appropriately.

The color interpolation converting part 552 is for performing pixel interpolation so that the RAW data is converted into image data in which all of the pixels contain data regarding all of the R, the G, and the B components. Further, the color interpolation converting part 552 converts each pixel value which is expressed by an RGB value into a YCrCb value which is formed by a luminance component and a color difference component. As a result, the color interpolation converting part 552 outputs image data of the YCrCb format.

The live view image generating part 553 generates image data which are to be displayed as a live view by the EVF 22 or the LCD 23 (hereinafter sometimes referred to as “live view image(s)”). More specifically, the live view image generating part 553 converts the resolution of image data into such a resolution at which the EVF 22 or the LCD 23 can display. Further, the live view image generating part 553 converts image data which are expressed in the YCrCb format into the YYCrCb format (two luminance components Y and a color difference component Cr·Cb). Since a pixel value regarding two neighboring pixels is expressed as one YYCrCb value (4 bytes) as a result of this, the data volume per pixel is 2 bytes.

Referring back to FIG. 4, the video controller 56 outputs image data to be displayed to the EVF 22 or the LCD 23 based on the setting of the display switch lever 17. When a live view image is to be displayed, the video controller 56 converts the pixel values (in the YYCrCb format) of the live view image back into RGB values and thereafter outputs the same to the EVF 22 or the LCD 23. At this stage, the video controller 56 controls the frame rate of the EVF 22 or the LCD 23.

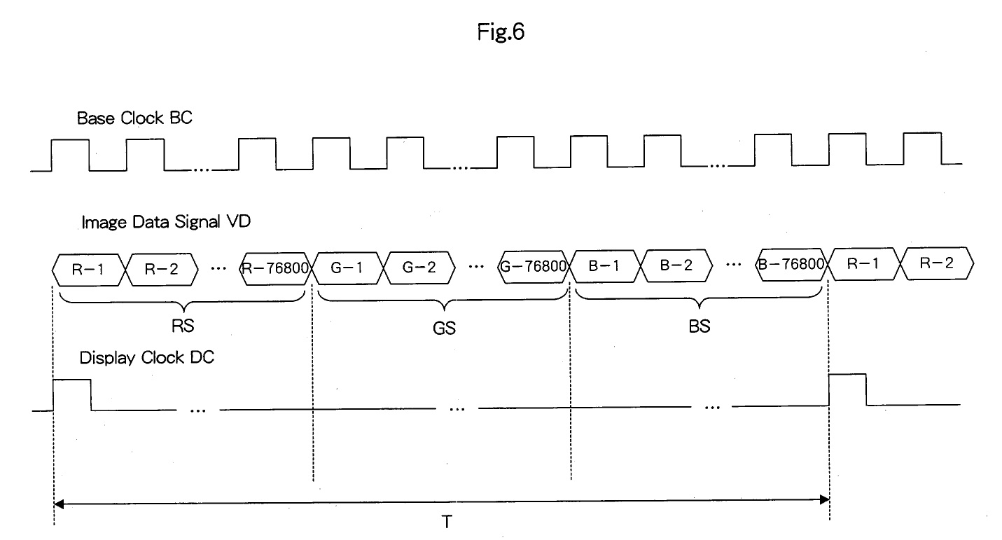

FIG. 6 shows an example of signals which are transmitted when the video controller 56 outputs image data to the EVF 22. As shown in FIG. 6, the video controller 56 provides the EVF 22 with three signals, namely, a base clock BC, a image data signal VD and a display clock DC.

The image data signal VD is a signal in one color per pixel representing each pixel value of image data which are to be transmitted, and since the EVF 22 is of the frame sequential method, a signal RS representing an R (red) image, a signal GS representing a G (green) image and a signal BS representing a B (blue) image are transmitted one after another as shown in FIG. 6. As such three signal trains each expresses an image in one of R, G and B, respectively, is transmitted in order, one frame is transmitted.

The base clock BC is transmitted as a base signal for each one of the image data signal VD. Meanwhile, the display clock DC is a signal which represents the beginning of a frame, and sent for every frame, i.e., at every start of transmission of the image data signal VD which represents an R image. Hence, the cycle T of the display clock DC is a frame updating cycle of the EVF 22, and the inverse number of the cycle T is the frame rate of the EVF 22.

In short, changing the cycle T of the display clock DC, the video controller 56 changes the frame rate of the EVF 22. The frame rate of the LCD 23, too, is changed in a similar manner.

The video controller 56 also outputs a image signal to an external monitor 62. After signal conversion into such scheme as NTSC, PAL and so on, the video controller 56 outputs a image signal at the video output terminal 26.

Referring back to FIG. 4, by the JPEG method, the compression part 57 compresses recording-purpose image data, based on the “image compression rate” which is set with the function dial 16, etc. The compression part 57 also expands compressed image data which are recorded in the memory card 9.

The memory card controller 58 controls inputting of data in and outputting of data from the memory card 9 which is attached to the digital camera 1. At the time of recording of image data, the memory card controller 58 gives a name of a predetermined system and records as an image file.

Via the serial interface 59, the timing generator 43, the lens drive part 33 and the operation member 10 described above are electrically connected to the bus line 45. This allows the CPU 51 to send various signals to these elements and control these elements, and receive various signals outputted from these elements.

Image data processed by the respective processing parts of the overall control part 50 are stored in the image memory 44 temporarily. To this end, areas for storing processed image data are prepared in the image memory 44.

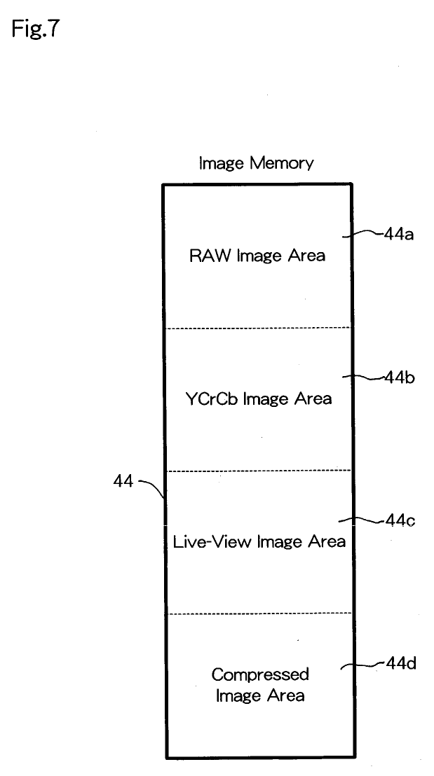

FIG. 7 is a drawing which schematically shows areas prepared in the image memory 44. As shown in FIG. 7, prepared in the image memory 44 are a RAW image area 44a for storing RAW image data outputted from the CCD 41, a YCrCb image area 44b for storing YCrCb-format image data outputted from the color interpolation converting part 552 of the image processing part 55, a live view image area 44c for storing a live view image of the YYCrCb format outputted from the live view image generating part 553 of the image processing part 50, a compressed image area 44d for storing image data of the JPEG format outputted from the compression part 57. Such allocation of the respective areas prepared in the image memory 44 is not fixed, but may be dynamically set in accordance with the operating state of the digital camera 1.

The CPU 51 calculates in accordance with the control program stored in the ROM 52, thereby realizing variety types of overall control of the digital camera 1 by the overall control part 50. Functions realized by such a control program include exposure control which determines exposure conditions such an f-number and a shutter speed, AF control which determines the focusing point of the lens units in the taking lens 3, image processing control which determines a variety of parameters in the image processing part 55, and the like in addition to control of operations of the respective portions described above of the digital camera.

Alternatively, such a control program may be read out from the memory card 9 storing the control program and newly installed.

<1-3. Operations in Recording Mode>

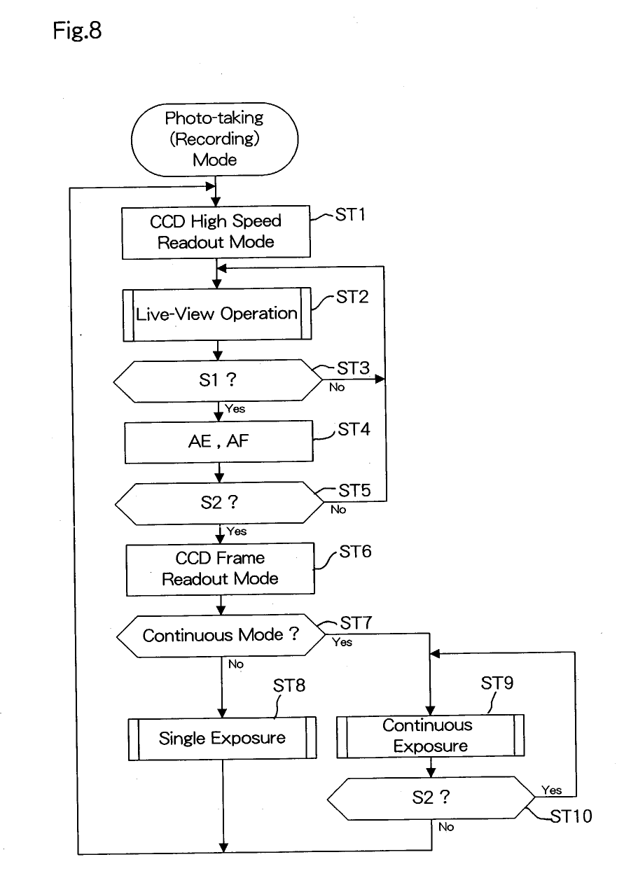

Operations in the recording mode of the digital camera 1 will now be described. FIG. 8 is a drawing which shows the flow of basic operations in the recording mode of the digital camera 1. The description below assumes that the display switch lever 17 has set the EVF 22 to show a live view, which is similar to the LCD 23 as well.

Set to the recording mode, first, the digital camera 1 enters a recording standby state after the CCD 41 is set to the draft mode (Step ST1), and a live view operation is carried out (Step ST2) which demands the EVF 22 to show image data of an object captured by the CCD 41 at 30 fps. The live view operation is repeated until the shutter button 11 gets half pressed (while No at Step ST3).

When the shutter button 11 in the recording standby state is half pressed (S1) (Yes at Step ST3), the CPU 51 performs exposure control and AF control, and parameters for the image processing part 55 are determined (Step ST4). In this condition, when the operation of the shutter button 11 is discontinued, the digital camera 1 returns to the recording standby state once again (No at Step ST5).

On the contrary, when the shutter button 11 is fully pressed (S2) (Yes at Step ST5), an operation of acquiring recording-purpose image data is performed. First, the CCD 41 is set to the frame mode (Step ST6), following which the CPU 51 judges whether the “drive mode” is set to “single frame recording” or “continuous frame recording” (Step ST7).

When the “drive mode” is “single frame recording,” a single frame recording operation of acquiring image data representing one frame is performed (Step ST8), whereas when the “drive mode” is “continuous frame recording,” while the shutter button 11 remains fully pressed, a “continuous frame recording” operation of acquiring a plurality pieces of image data in row is performed (Step ST9, Step ST10). Such operation control on “single frame recording” or “continuous frame recording” is realized by the CPU 51 and the timing generator 43.

As the operation of acquiring recording-purpose image data completes, the CCD 41 is set to the draft mode once again (Step ST1), and the recording standby state comes back again.

While image data of a subject are acquired each during the live view operation (Step ST2), the single frame recording operation (Step ST8) and the continuous frame recording operation (Step ST9) in the series of operations under the recording modes described above, the contents of the processing performed on the acquired image data are different from each other. Since a load upon the digital camera 1 is relatively large during the continuous frame recording operation in particular, processing for reducing the load is carried out. The step ST7 corresponds to a judgment of whether the load upon the digital camera 1 is larger than a normal load during single frame recording (reference load).

A description will now be given on the contents of the processing performed on image data in the digital camera 1 during the live view operation (Step ST2), the single frame recording operation (Step ST8) and the continuous frame recording operation (Step ST9).

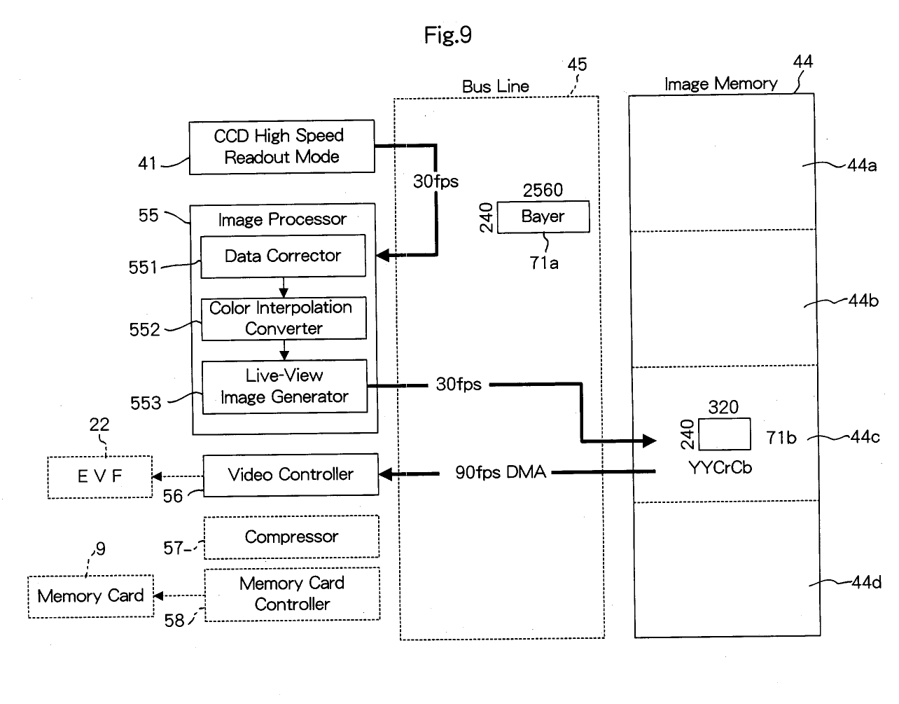

FIG. 9 is a drawing for describing the content of the processing performed on image data during the live view operation (Step ST2) of the digital camera 1. In FIG. 9, the arrows denote flows of transfer of image data which are processed, among which the thick arrows in particular denote transfer of image data via the bus line 45.

Live view-purpose image data 71a captured by the CCD 41 which is set to the draft mode, as described earlier, contain 2560 pixels in the horizontal direction×240 pixels in the vertical direction in the RAW data. The image data 71a, after outputted from the CCD 41, are fed to the image processing part 55 via the bus line 45.

The image data 71a thus fed to the image processing part 55 are subjected to predetermined correction within the data correction part 551 and then converted into the YCrCb format by the color interpolation converting part 552. The image data are further converted by the live view image generating part 553 into image data of the YYCrCb format containing 320 pixels in the horizontal direction×240 pixels in the vertical direction, whereby a live view image 71b is generated. Thus generated live view image 71b is transferred via the bus line 45 and stored in the live view image area 44c within the image memory 44.

Acquisition of the image data 71a by the CCD 41 and generation of the live view image 71b from the image data 71a described above are performed at 30 fps. In other words, the live view image 71b within the image memory 44 is updated every 1/30 second.

The live view image 71b stored within the image memory 44 is DMA-transferred to the video controller 56 via the bus line 45 in accordance with a request supplied to the bus controller 54 from the video controller 56. Hence, the live view image 71b is transferred directly to the video controller 56 without going through the processing performed by the CPU 51 and independently of acquisition of the image data 71a and generation of the live view image 71b described above.

As for the live view image 71b transferred to the video controller 56, after the values of the respective pixels are converted into RGB values, images in each color are outputted to the EVF 22 one after another. At this stage, the frame rate of the EVF 22 is controlled by the video controller 56 such that the frame rate will become 90 fps which is a reference frame rate. That is, the video controller 56 adjusts the cycle T of the display clock DC so that image data displayed by the EVF 22 will be updated 90 times per second (so that an image in each color will be updated 90×3=270 times since the method is the frame sequential method). The reference frame rate may be set to an optimal value in accordance with a display device.

Every time image data representing one frame are outputted to the EVF 22, the video controller 56 requests the bus controller 54 to transfer the next live view image 71b. Since the reference frame rate of the EVF 22 is 90 fps, transfer of the live view image 71b to the video controller 56 from the image memory 44 is also at 90 fps.

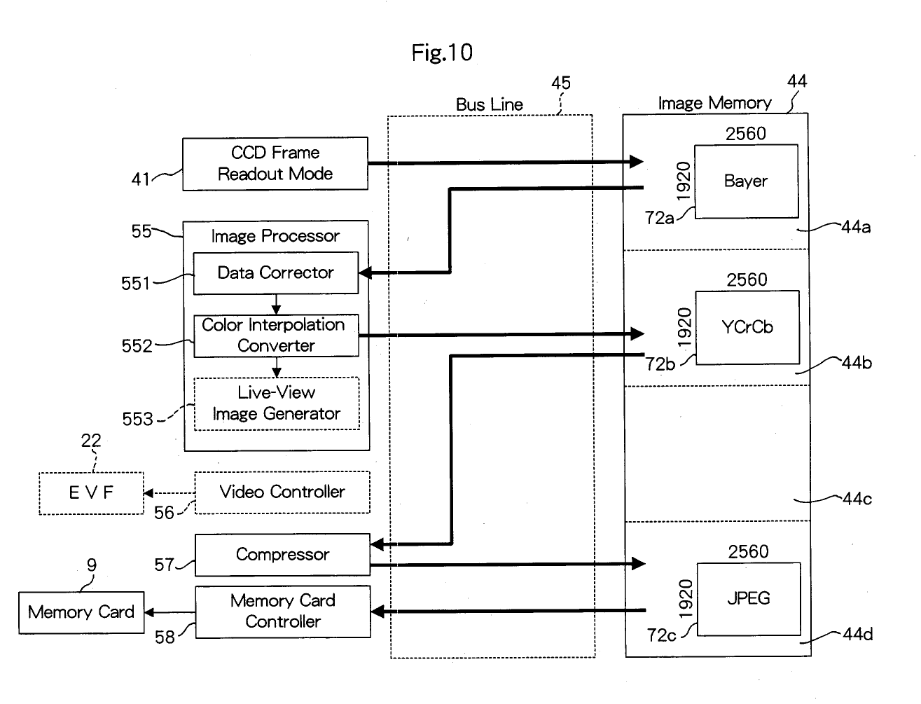

Referring to FIG. 10, the content of the processing performed on image data during the single frame recording operation (Step ST8) of the digital camera 1 will now be described. In FIG. 10, too, the arrows denote flows of transfer of image data which are processed, among which the thick arrows in particular denote transfer of image data via the bus line 45.

Recording-purpose image data 72a captured by the CCD 41 which is set to the frame mode, as described earlier, contain 2560 pixels in the horizontal direction×1920 pixels in the vertical direction in the RAW data. The image data 72a, after outputted from the CCD 41, are temporarily stored in the RAW image area 44a of the image memory 44 via the bus line 45.

The image data 72a stored in the image memory 44 are then transferred to the image processing part 55 via the bus line 45. The image data are subjected to predetermined correction within the data correction part 551 and then converted into the YCrCb format by the color interpolation converting part 552. Thus generated image data 72b of the YCrCb format are thereafter transferred via the bus line 45 and stored in the YCrCb image area 44b of the image memory 44.

Following this, the image data 72b are transferred to the compression part 57 via the bus line 45 and compressed in the compression part 57 by the JPEG method. Thus generated image data 72c of the JPEG format are again transferred via the bus line 45 and stored in the compressed image area 44d of the image memory 44. The image data are further transferred via the bus line 45 to the memory card controller 58 and recorded as an image file in the memory card 9.

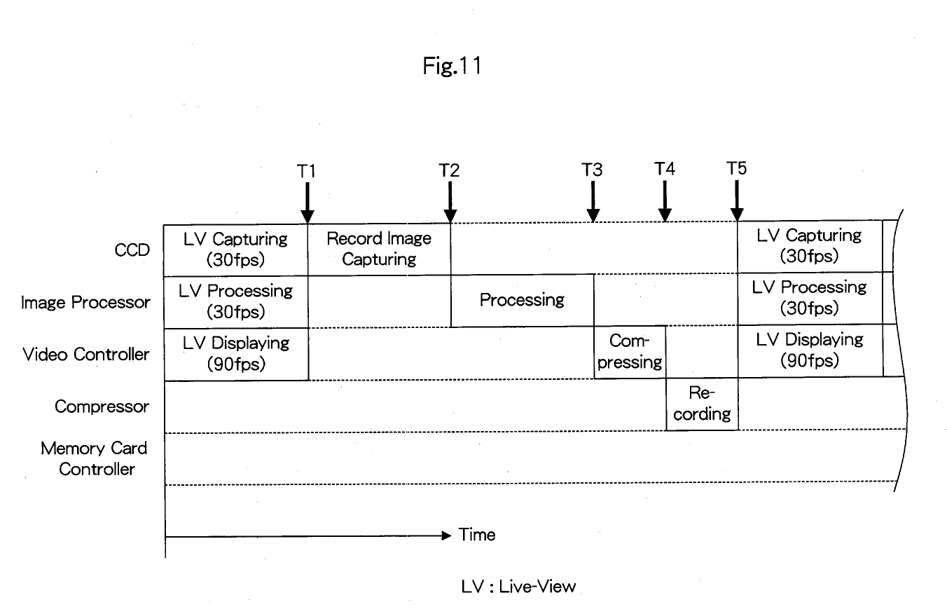

FIG. 11 shows, along the horizontal direction which denotes time, the flow of the processing of transition to the single frame recording operation (Step ST8) from the live view operation (Step ST2) described above and transition to the live view operation (Step ST2) again. In FIG. 11, T1 denotes the time at which the shutter button 11 is fully pressed.

As shown in FIG. 11, up until the time TI, the live view operation is ongoing (FIG. 9). As the shutter button 11 is fully pressed at the time T1, the single frame recording operation (FIG. 10) is carried out. In other words, the CCD 41 acquires the image data 72a and stores the same in the image memory 44, the image processing part 55 generates the image data 72b of the YCrCb format at the time T2, the compression part 57 generates the image data 72c of the JPEG format at the time T3, and the memory card controller 58 records in the memory card 9 at the time T4. At the time T5, the flow returns again to the live view operation (FIG. 9).

As shown in FIG. 11, during the single frame recording operation, pieces of image data are processed at relatively long intervals, and therefore, the volume of data transferred within the digital camera 1 will not exceed the capacity of the bus line 45, which in turn ensures a relatively low load upon the digital camera 1.

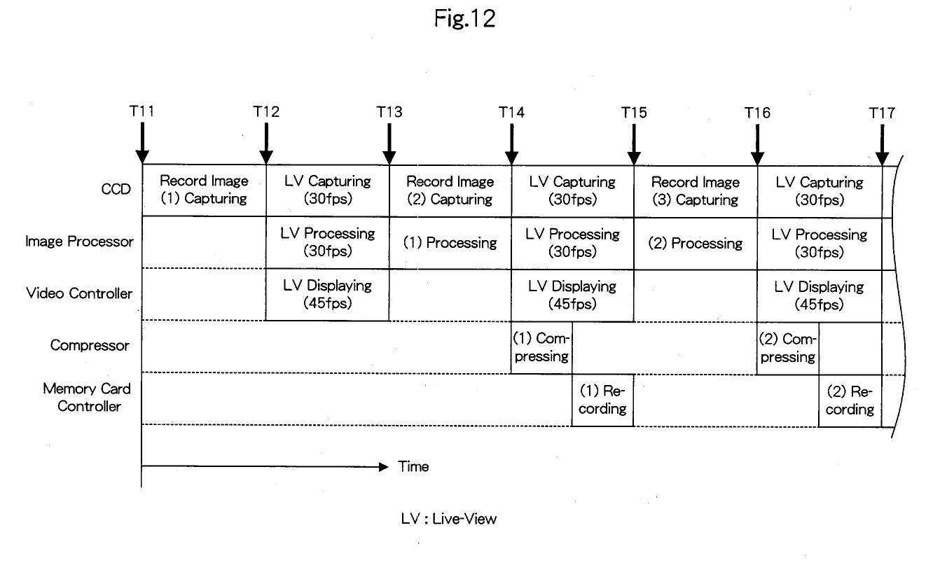

Referring to FIG. 12, the flow of the processing performed on image data during the continuous frame recording operation (Step ST9) of the digital camera 1 will now be described. In FIG. 12, T11 denotes the time at which the shutter button 11 is fully pressed, and it is assumed that the shutter button 11 remains fully pressed at and after time T11.

For appropriate framing, it is preferable that a user confirms the condition of an object as a live view even during continuous frame recording. Hence, during the continuous frame recording operation of the digital camera 1, a live view is displayed during continuous acquisition of recording-purpose image data of an object. While it is necessary to perform the single frame recording operation shown in FIG. 10 and the live view operation shown in FIG. 9 alternately to realize this, mere alternating execution of these operations will not produce continuous frame recording at a high speed. Hence, in the digital camera 1, the respective processing parts execute processing in parallel as described below, thereby making continuous frame recording relatively at a high speed possible. This operation will now be described, in the order of the respective points T11, T12, T13 . . . in time.

T11-T12: The CCD 41 which is set to the frame mode acquires the first piece of recording-purpose image data, and stores the same in the image memory 44.

T12-T13: The CCD 41, the image processing part 55 and the video controller 56 are temporarily switched to the live view operation. That is, the CCD 41 is set to the draft mode and acquires a live view-purpose image, the image processing part 55 processes this live view-purpose image data, and the video controller 56 makes the EVF 22 display a live view image. At this stage, the first piece of recording-purpose image data stays stored in the image memory 44.

T13-T14: The CCD 41 is set to the frame mode, acquires the second piece of recording-purpose image data, and stores the same in the image memory 44. At this stage, the first piece of recording-purpose image data is transferred to the image processing part 55, subjected to predetermined processing, and become image data of the YCrCb format.

T14-T15: The CCD 41, the image processing part 55 and the video controller 56 are temporarily switched to the live view operation. At this stage, the first piece of recording-purpose image data is compressed by the compression part 57 and then recorded by the memory card controller 58 in the memory card 9. Meanwhile, the second piece of recording-purpose image data remains stored in the image memory 44.

T15-T16: The CCD 41 acquires the third piece of recording-purpose image data. The operations at this stage are similar to the operations from the time T13 to the time T14. In other words, at and after the time T15, operations similar to the operation from the time T13 to the time T14 and operations similar to the operation from the time T14 to the time T15 are repeated alternately.

During the operations from the time T14 to the time T15, the CCD 41, the image processing part 55, the video controller 56, the compression part 57 and the memory card controller 58 all perform the respective operations. This makes the volume of data transferred on the bus line 45 reach a peak, imposing the maximum load upon the bus line 45.

Noting this, during the continuous frame recording operation, the video controller 56 reduces the frame rate of the EVF 22 which displays a live view from 90 fps, which is the reference frame rate, down to 45 fps. In short, the video controller 56 adjusts the cycle T of the display clock DC so that image displayed by the EVF 22 will be updated 45 times per second.

As the frame rate of the EVF 22 is changed in this manner, a request for a live view image to the bus controller 54 from the video controller 56 is given also at 45 fps. This cuts the volume of data transferred per second on the bus line 45 to the video controller 56 from the image memory 44 down to ½(=45 fps/90 fps). The volume of data transferred via the bus line 45 is consequently suppressed, and the load upon the bus line 45 therefore decreases. Since this enables transfer of image data via the bus line 45 at a relatively high speed, high-speed operations of the digital camera 1 are guaranteed.

The digital camera 1 according to the first preferred embodiment determines that a load upon the same is larger during continuous frame recording than during single frame recording and reduces the frame rate of the EVF 22 or the LCD 23. Hence, a load upon the digital camera 1 is lowered. This ensures high-speed operations of the digital camera 1 during continuous frame recording, and leads to an improvement in operability.

<2. Second Preferred Embodiment>

A second preferred embodiment of the present invention will now be described. A structure and an internal structure of a digital camera 1 according to the second preferred embodiment are similar to those shown in FIGS. 1 through 4. Operations of the digital camera 1 according to the second preferred embodiment are different from the operations of the digital camera 1 according to the first preferred embodiment only in terms of continuous frame recording. Nothing this, the difference from the first preferred embodiment will be mainly described in the following.

While the frame rate of the EVF 22 is changed during the continuous frame recording operation according to the first preferred embodiment, the second preferred embodiment requires to reduce the size of a live view image to be generated.

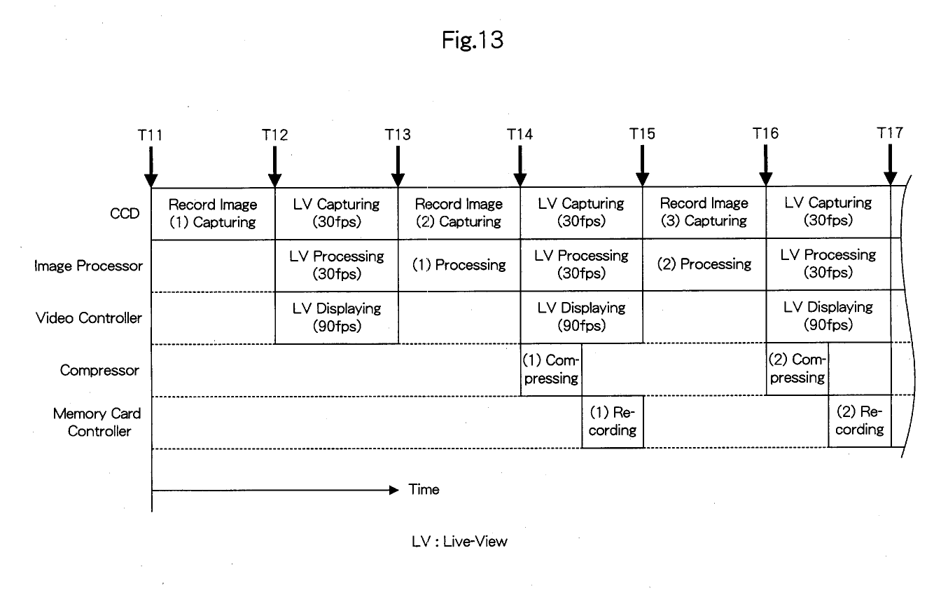

FIG. 13 shows, along the horizontal direction which denotes time, the flow of processing performed on image data during the continuous frame recording operation of the digital camera 1 according to the second preferred embodiment. FIG. 13 is different from FIG. 12, which shows the continuous frame recording operation of the first preferred embodiment, in that the frame rate of the EVF 22 controlled by the video controller 56 is not 45 fps but is 90 fps. That is, the frame rate of the EVF 22 is not changed in the digital camera 1 according to the second preferred embodiment but remains at 90 fps which is the reference frame rate.

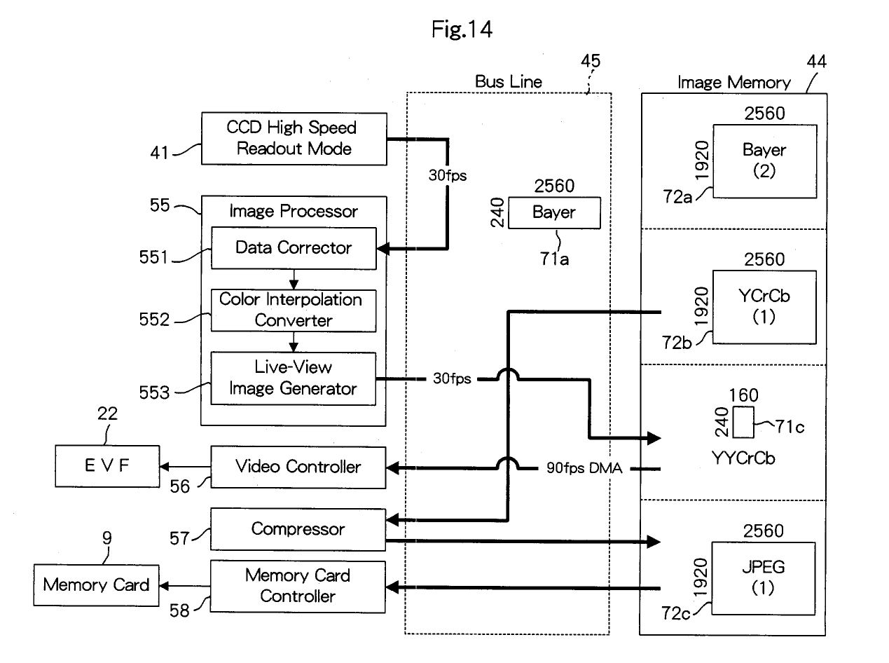

FIG. 14 is a drawing for describing the content of processing performed on image data from the time T14 to the time T15 shown in FIG. 13. In FIG. 14, the arrows denote flows of transfer of image data which are processed, among which the thick arrows in particular denote transfer of image data via the bus line 45.

As described in relation to the first preferred embodiment, from the time T14 to the time T15, the first piece of image data 72b for recording of the YCrCb format is compressed by the compression part 57 to thereby become the image data 72c of the JPEG format, and recorded by the memory card controller 58 in the memory card 9. Meanwhile, the second piece of image data 72a for recording of the RAW data remains stored in the image memory 44. In parallel to this, the CCD 41, the image processing part 55 and the video controller 56 perform the live view operation.

The live view-purpose image data 71a captured by the CCD 41 which is set to the draft mode, as described earlier, contain 2560 pixels in the horizontal direction×240 pixels in the vertical direction of the RAW data, and are fed to the image processing part 55 via the bus line 45.

The image data 71a thus fed to the image processing part 55 are subjected to predetermined correction within the data correction part 551 and then converted into the YCrCb format by the color interpolation converting part 552. The image data are further converted by the live view image generating part 553 into a live view image 71c of the YYCrCb format.

While the live view image 71b generated in the recording standby state has a reference size of 320 pixels in the horizontal direction×240 pixels in the vertical direction, the live view image 71c generated during the continuous frame recording operation contains 160 pixels in the horizontal direction×240 pixels in the vertical direction. In other words, the number of pixels in the horizontal direction is down to ½, and therefore, the size of the live view image 71c is ½ of the reference size of the live view image 71b generated in the recording standby state.

Thus generated live view image 71b is stored in the live view image area 44c of the image memory 44 via the bus line 45, and DMA-transferred to the video controller 56 based on a request issued from the video controller 56 to the bus controller 54.

The horizontal size of the live view image 71b DMA-transferred to the video controller 56 in this fashion is interpolated by the video controller 56 by two times and the live view image 71b accordingly becomes an image which contains 320 pixels in the horizontal direction×240 pixels in the vertical direction. Following this, the values of the respective pixels are converted into RGB values in a similar manner to that in the recording standby state, and thereafter transmitted to the EVF 22.

The live view image 71c is transferred to the video controller 56 from the image memory 44 at 90 fps which is the same as in the recording standby state. Hence, when the size of the live view image 71c becomes ½ of the reference size, the volume of data transferred per second on the bus line 45 to the video controller 56 from the image memory 44 becomes ½. In addition, the volume of data transferred at 30 fps to the image memory 44 from the image processing part 55 also becomes ½.

The volume of data transferred via the bus line 45 is consequently suppressed, and the load upon the bus line 45 therefore decreases. Since this enables transfer of image data via the bus line 45 at a relatively high speed, high-speed operations of the digital camera 1 are guaranteed.

The digital camera 1 according to the second preferred embodiment requires to decrease the size of a live view image to be displayed by the EVF 22 or the LCD 23 during the continuous frame recording operation. Hence, it is possible to reduce a load upon the digital camera 1, ensures high-speed operations of the digital camera 1 during the continuous frame recording operation, and improve the operability.

<3. Third Preferred Embodiment>

A third preferred embodiment of the present invention will now be described. A structure and an internal structure of a digital camera 1 according to the third preferred embodiment are similar to those shown in FIGS. 1 through 4. Further, operations of the digital camera 1 according to the third preferred embodiment are different from the operations of the digital camera 1 according to the first preferred embodiment only in terms of continuous frame recording. Noting this, the difference from the first preferred embodiment will be mainly described in the following.

While the output mode of the CCD 41 is changed sequentially to acquire live view-purpose image data during the continuous frame recording operation according to the first preferred embodiment, the output mode of the CCD 41 is not changed and instead, a live view image is generated from recording-purpose image data according to the third preferred embodiment.

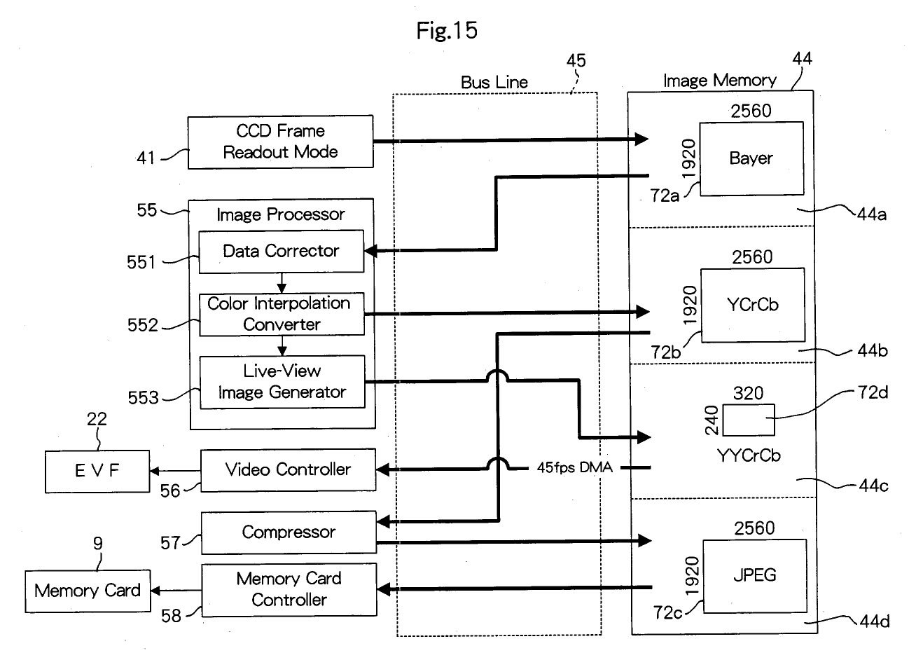

FIG. 15 shows the content of processing performed on image data during the continuous frame recording operation of the digital camera 1 according to the third preferred embodiment. In FIG. 15, the arrows denote flows of transfer of image data which are processed, among which the thick arrows in particular denote transfer of image data via the bus line 45.

The image data for recording 72a captured by the CCD 41 which is set to the frame mode, which contain 2560 pixels in the horizontal direction×1920 pixels in the vertical direction of the RAW data, are stored in the RAW image area 44a of the image memory 44 via the bus line 45 after outputted from the CCD 41.

The recording-purpose image data 72a stored in the image memory 44 are then transferred to the image processing part 55 via the bus line 45. The image data are subjected to predetermined correction within the data correction part 551 and converted into the YCrCb format by the color interpolation converting part 552.

Image data 72b of the YCrCb format generated by the color interpolation converting part 552 are transferred via the bus line 45, and stored in the YCrCb image area 44b of the image memory 44. This image data 72b, after compressed by the compression part 57 to thereby become image data 72c of the JPEG format as in the first preferred embodiment, are recorded by the memory card controller 58 in the memory card 9.

The image data 72b of the YCrCb format generated by the color interpolation converting part 552 are fed also to the live view image generating part 553. The live view image generating part 553 reduces, down to ⅛, the pixels in both the horizontal and the vertical directions of the image data 72b of the YCrCb format consisting of 2560 pixels in the horizontal direction×1920 pixels in the vertical direction, thereby generating image data containing 320 pixels in the horizontal direction×240 pixels in the vertical direction. In addition, this image data are converted into the YYCrCb format, whereby a live view image 72d is generated. The generated live view image 72d is stored in the live view image area 44c of the image memory 44.

The live view image 72d thus stored in the image memory 44 is transferred to the video controller 56 at 45 fps as in the first preferred embodiment, and displayed by the EVF 22. In this manner, the live view image 72d which is used as a display shown by the EVF 22 is generated from the recording-purpose image data 72a.

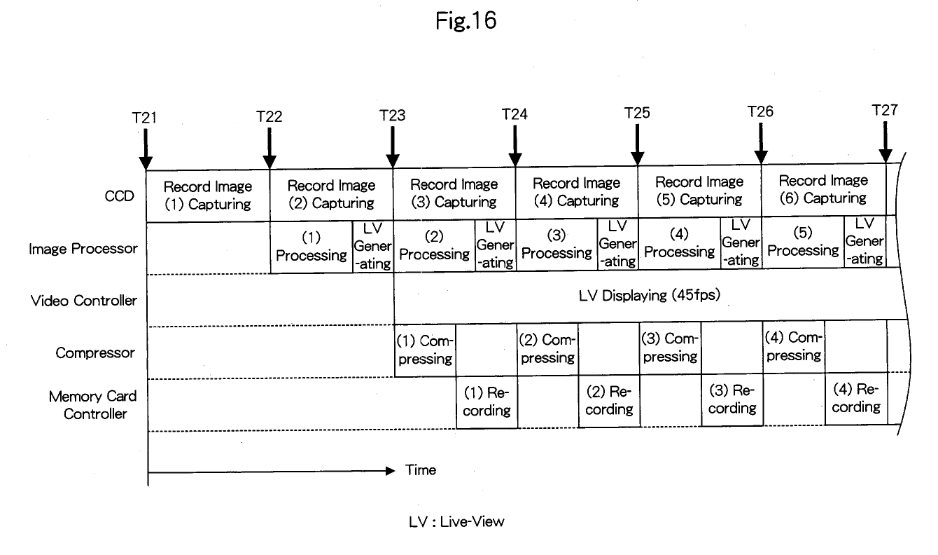

Referring to FIG. 16, the flow of the processing performed on image data during the continuous frame recording operation of the digital camera 1 will now be described. In FIG. 16, T21 denotes the time at which the shutter button 11 is fully pressed, and it is assumed that the shutter button 11 remains fully pressed at and after this point in time.

Since the live view image 72d is generated from the recording-purpose image data 72a, the third preferred embodiment does not require the CCD 41 to acquire live view-purpose image data unlike in the first preferred embodiment. Hence, the CCD 41 successively acquires recording-purpose image data while remaining in the frame mode. This operation will now be described, in the order of the respective points T21, T22, T23 . . . in time.

T21-T22: The CCD 41 which is set to the frame mode acquires the first piece of recording-purpose image data, and stores the same in the image memory 44.

T22-T23: While remaining in the frame mode, the CCD 41 acquires the second piece of recording-purpose image data and stores the same in the image memory 44. At this stage, the first piece of recording-purpose image data is transferred to the image processing part 55 which will then perform predetermined processing on the first piece of recording-purpose image data and thereby generate image data of the YCrCb format. Thus generated image data of the YCrCb format are stored in the image memory 44, while concurrently fed to the live view image generating part 553. The live view image generating part 553 then generates a live view image.

T23-T24: While remaining in the frame mode, the CCD 41 acquires the third piece of recording-purpose image data and stores the same in the image memory 44. The image processing part 55 performs predetermined processing on the second piece of recording-purpose image data and accordingly generates image data of the YCrCb format, and further generates a live view image. The video controller 56 accepts, at 45 fps, the live view image generated from the first piece of recording-purpose image data, and makes the EVF 22 display the live view image. The compression part 57 compresses the first piece of recording-purpose image data of the YCrCb format, and the memory card controller 58 records thus compressed first piece of image data.

At and after T24: Operations similar to the operation from the time T23 to the time T24 are repeated. That is, at and after this, image data on an object are acquired in the cycle from T23 to T24, realizing continuous frame recording at a very high speed.

As described above, according to the third preferred embodiment, a live view image is not generated from image data which the CCD 41 acquires in the draft mode, but from recording-purpose image data which are acquired in the frame mode. This eliminates the necessity of switching the operation of the CCD 41 and acquiring live view-purpose image data, which in turn suppresses the volume of data transferred on the bus line 45 and reduces a load upon the digital camera. Further, since the CCD 41 can successively acquire recording-purpose image data, it is possible to perform continuous frame recording at a very high speed.

<4. Modifications>

While the foregoing has described the present invention in relation to the preferred embodiments, the present invention is not limited to the preferred embodiments described above but may be modified in a variety of manners.

For example, when the frame rate of the LCD 23 is fixed and the frame rate of the EVF 22 is changeable, the present invention may be applied only to displaying of an image by the EVF 22 based on the setting of the display switch lever 17.

Further, although the preferred embodiments described above have been described requiring the EVF 22 or the LCD 23 to display a live view image, the present invention is applicable even to displaying of a live view image by the external monitor 62 for instance. When the frame rate of the external monitor 62 is changeable for example, an approach similar to that according to the first preferred embodiment is applicable, and even when the frame rate is fixed, an approach similar to that according to the second preferred embodiment is applicable.

In addition, while the first preferred embodiment requires to decrease the frame rate of the EVF 22 and the second preferred embodiment requires to reduce the size of a live view image, these two may be combined with each other. Such makes it possible to further reduce a load upon the digital camera, and allows the digital camera to operate at a high speed.

Although the third preferred embodiment requires to lower the frame rate of the EVF 22 as in the first preferred embodiment, the size of a live view image may be reduced as in the second preferred embodiment.

Although whether a load upon the digital camera 1 is large or small is determined based on whether single frame recording is ongoing or continuous frame recording is ongoing in the first through the third preferred embodiments, a decision may be made based on the number of tasks which are being processed in parallel.

Calculation executed by the CPU in accordance with a program may realize all or a part of the functions which according to the preferred embodiments above are realized by electric circuits.

As described above, when a load upon the digital camera is larger than the reference load which is imposed during the normal operations, the frame rate of the display device is reduced, and therefore, the load upon the digital camera is reduced.

When a load upon the digital camera is larger than the reference load which is imposed during the normal operations, the size of displaying-purpose image data is decreased which is to be displayed by the display device, and therefore, the load upon the digital camera is reduced.

It is possible to display live view-purpose image by the display device while reducing a load upon the digital camera.

It is possible to effectively reduce a load upon the digital camera during continuous frame recording which increases a load upon the digital camera.

Since displaying-purpose image data to be displayed by the display device are generated not from simplified image data but from recording-purpose image data, it is not necessary to switch the operation of image capturing device and acquire simplified image data, and therefore, it is possible to improve the speed of continuous frame recording while reducing a load upon the digital camera.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A digital camera equipped with an image capturing device which acquires image data of an object, comprising:
display controller which makes a display device whose frame rate is changeable display displaying-purpose image at a predetermined reference frame rate; and
judging part which determines a load upon the digital camera,
wherein said display controller reduces the frame rate of the display device smaller than said reference frame rate when said judging part determines that a load upon the digital camera is larger than a reference load which is imposed during normal operations.

2. A digital camera according to claim 1 further comprising:
an image capture controller which makes the image capturing device execute continuous frame recording of acquiring a plurality pieces of image data representing an object over successive points in time,
wherein said judging part determines that a load upon the digital camera is larger than the reference load which is imposed during normal operations when the image capture controller makes the image capturing device execute continuous frame recording.

3. A digital camera according to claim 1, the displaying-purpose image data contain live view-purpose image data.

4. A digital camera according to claim 3 further comprising:
an image capture controller which makes the image capturing device execute continuous frame recording of acquiring a plurality pieces of image data representing an object over successive points in time,
wherein said judging part determines that a load upon the digital camera is larger than the reference load which is imposed during normal operations when the image capture controller makes the image capturing device execute continuous frame recording.

5. A digital camera equipped with an image capturing device which acquires image data of an object, comprising:
image data generator which generates, in a predetermined reference size, displaying-purpose image data which are to be displayed as an image by a predetermined display device; and
judging part which determines a load upon the digital camera,
wherein the image data generator reduces the size of said displaying-purpose image data smaller than said reference size when said judging part determines that a load upon the digital camera is larger than a reference load which is imposed during normal operations.

6. A digital camera according to claim 5 further comprising:
an image capture controller which makes the image capturing device execute continuous frame recording of acquiring a plurality pieces of image data representing an object over successive points in time,
wherein said judging part determines that a load upon the digital camera is larger than the reference load which is imposed during normal operations when the image capture controller makes the image capturing device execute continuous frame recording.

7. A digital camera according to claim 5, the displaying-purpose image data contain live view-purpose image data.

8. A digital camera according to claim 7 further comprising:
an image capture controller which makes the image capturing device execute continuous frame recording of acquiring a plurality pieces of image data representing an object over successive points in time,
wherein said judging part determines that a load upon the digital camera is larger than the reference load which is imposed during normal operations when the image capture controller makes the image capturing device execute continuous frame recording.

9. A digital camera which is capable of executing continuous frame recording during which a plurality pieces of recording-purpose image data are acquired over successive points in time, comprising:
an image capturing device which is capable of switching between a first operation of acquiring said recording-purpose image data and a second operation of acquiring simplified image data whose resolution is lower than that of the recording-purpose image data; and
an image data generator which generates displaying-purpose image data which are to be displayed by a predetermined display device,
wherein when the digital camera is in a recording standby state, the image data generator generates the displaying-purpose image data from the simplified image data acquired during the second operation of the image capturing device, and while continuous frame recording is ongoing in the digital camera, the image data generator generates the displaying-purpose image data from the recording-purpose image data acquired during the first operation of the image capturing device.
